(19) United States
(12) Patent Application Publication
(10) Pub. No.: US 2026/0087099 A1
(43) Pub. Date: Mar. 26, 2026

(54) ARTIFICIAL INTELLIGENCE SYSTEM FOR OVERSAMPLING INPUT DATA AND METHOD THEREOF

(71) Applicant: LG MANAGEMENT DEVELOPMENT INSTITUTE CO., LTD., Seoul (KR)

(72) Inventors: Chang Young PARK, Seoul (KR); Jae Wan LEE, Seoul (KR); Hong Jun YANG, Seoul (KR); Se Hui HAN, Seoul (KR)

(21) Appl. No.: 19/408,952

(22) Filed: Dec. 4, 2025

Related U.S. Application Data
(63) Continuation of application No. PCT/KR2025/013513, filed on Sep. 3, 2025.

(30) Foreign Application Priority Data
Sep. 13, 2024 (KR) 10-2024-0125807
Apr. 15, 2025 (KR) 10-2025-0048779

(51) Int. Cl. G06F 18/214; G06N 20/00

(52) U.S. Cl. CPC G06F 18/214; G06N 20/00

(57) ABSTRACT

An artificial intelligence system performing operations including: an operation of calculating an importance score for data points of a dataset, an operation of calculating an oversampling rate for each of the data points, an operation of calculating a sample weight based on the oversampling rate for each of the data points, and an operation of oversampling the data points in correspondence to the calculated sample weight.

### CROSS REFERENCE TO RELATED APPLICATION(S)

This application is a Bypass Continuation of International Patent Application No. PCT/KR2025/013513, filed on Sep. 3, 2025, which claims priority from and the benefit of Korean Patent Application Nos. 10-2024-0125807, filed on Sep. 13, 2024 and 10-2025-0048779, filed on Apr. 15, 2025, which are hereby incorporated by reference for all purposes as if fully set forth herein.

### BACKGROUND

### Field

Embodiments of the invention relate generally to an artificial intelligence (AI) system, and more particularly, to an AI system for oversampling input data, which resolves imbalance in input data and improves performance of the AI system by oversampling input data of the AI system, and a method thereof.

### Discussion of the Background

Recently, artificial intelligence (AI) technology has been drawing attention throughout the society as it shows advanced development trends. AI refers to computers performing human-specific intellectual capabilities with high-level capability, such as “computer brains that execute works that can be accomplished with human intelligence,” “engineering and science that creates intelligent machines,” and “a series of algorithmic systems designed to think, sense, and act like humans.”

AI is being introduced as providing highly integrated smart spaces when used together with augmented reality, the Internet of Things, edge computing, digital twins, and the like, and is being emphasized as a core new technology that will lead the era of the Fourth Industrial Revolution. In addition, AI is drawing attention as a next-generation growth engine capable of evolving industrial ecosystems beyond solving standardized problems, and is being actively applied not only to IT, medical care, agriculture, energy, automobiles, and robots, but also to knowledge service industries such as distribution, finance, law, education, real estate, advertisement, and telecommunications. In other words, all existing systems are preparing for a new era by combining with AI, from industries that promote convenience or improvement in real life to all aspects of culture and arts in the society.

In fields such as medicine, finance, and manufacturing, data collection costs are often high or rare data is frequently used. In such cases, a small amount of tabular data is used for regression analysis. However, AI models trained based on small amounts of data have low generalization performance, high risk of overfitting, and problems in that model performance is degraded due to data imbalance and sparsity. To solve these problems, data oversampling techniques have been proposed, and such data oversampling techniques typically include synthetic minority oversampling technique (SMOTE) and adaptive synthetic sampling (ADASYN). These conventional data oversampling techniques generate data from a small number of classes to mitigate data imbalance.

However, such conventional oversampling techniques are effective when applied to classification problems with continuous input variables, but they have a problem in that it is difficult to apply them when categorical input variables are included in the data.

The above information disclosed in this Background section is only for understanding of the background of the inventive concepts, and, therefore, it may contain information that does not constitute prior art.

### SUMMARY

The invention provides an artificial intelligence (AI) system capable of achieving excellent performance even with small-scale tabular input data by dynamically selecting an oversampling rate based on the feature distribution of input data in a tabular form and performing oversampling and a method thereof

Additional features of the inventive concepts will be set forth in the description which follows, and in part will be apparent from the description, or may be learned by practice of the inventive concepts.

According to one or more embodiments of the invention, a system includes: at least one processor and at least one memory storing instructions or information executed by the at least one processor. Operations performed by the instructions or information executed by the at least one processor include an operation of calculating an oversampling rate for each of data points of a dataset, an operation of calculating a sample weight based on the oversampling rate for the data points, and an operation of oversampling the data points in correspondence to the calculated sample weight.

The dataset may include a plurality of data points each composed of a feature vector and a target value of the feature vector.

The system may further include an operation of calculating an importance score for the data points, wherein the operation of calculating the importance score may include: an operation of calculating a change amount of target values of the data points to calculate an importance score and an operation of generating oversampling tubular data by selecting some of the data points having a high importance score.

The oversampling rate may be calculated as a rate of number of times that each feature value of a plurality of features included in the data points is duplicated within the dataset.

The sample weight may be calculated by multiplying a plurality of oversampling rates of the data points.

The data points may be replicated as many times as the calculated sample weight and included in a dataset.

According to yet another embodiment of the invention, a computerized method includes: calculating, through a processor, an oversampling rate for each of data points of a dataset stored in a memory; calculating, through the processor, a sample weight for each of the data points based on the oversampling rate stored in the memory; and oversampling, through the processor, the data points in correspondence to the calculated sample weight stored in the memory.

The dataset may include a plurality of data points each composed of a feature vector and a target value of the feature vector.

The method may further include calculating an importance score for the data points, wherein, in the calculating the importance score, a change amount of target values of the data points may be calculated to calculate an importance score, and oversampling tubular data may be generated by selecting some of the data points having a high importance score.

The oversampling rate may be calculated as a rate of number of times that each feature value of a plurality of features included in the data points is duplicated within the dataset divided by a total number of the data points.

In the calculating the sample weight, the sample weight may be calculated by multiplying a plurality of oversampling rates of the data points and rounding multiplication results.

In the oversampling the data points, the data points may be replicated as many times as the calculated sample weight and included in a dataset.

According to yet another embodiment of the invention, an application-specific integrated circuit includes: a memory storing information and instructions and a functional block including at least one processor requesting access to the memory. The memory may store instructions or information including: an operation of calculating an oversampling rate for each of data points of a dataset, an operation of calculating a sample weight based on the oversampling rate for the data points, and an operation of oversampling the data points in correspondence to the calculated sample weight.

According to yet another embodiment of the invention, a computerized method includes: calculating, through a processor, an oversampling rate of each of data points of a dataset including positive electrode material property information of a tubular form stored in a memory; calculating, through the processor, a sample weight based on the oversampling rate stored in the memory for each of the data points; and oversampling, through the processor, the data points in correspondence to the calculated sample weight stored in the memory. At least some of the positive electrode material property information of the dataset are oversampled and stored in the memory.

The dataset may include a plurality of data points each composed of a positive electrode material property vector and a target value of the positive electrode material property vector, and the dataset may include positive electrode material property information including a positive electrode active material and doping elements.

The method may further include calculating an importance score for the data points, and in the calculating the importance score, a change amount of target values of the data points may be calculated to calculate an importance score, and oversampling tubular data may be generated by selecting some of the data points having a high importance score.

The oversampling rate may be calculated as a rate of number of times that each feature value of the doping elements included in the data points is duplicated within the dataset divided by a total number of the data points.

In the calculating the sample weight, the sample weight may be calculated by multiplying a plurality of oversampling rates of the data points and rounding multiplication results.

In the step of oversampling the data points, the data points may be replicated as many times as the calculated sample weight and included in a dataset so that some of the doping elements are oversampled.

The positive electrode material property information may include aluminum, zirconium, magnesium, titanium, boron, fluorine, tungsten, molybdenum, gallium, nitrogen group, and calcium as doping elements for doping the positive electrode material, and property information of some of the doping elements is oversampled by calculating an oversampling rate and a sample weight for each of the doping elements.

The method may further include: inputting data-augmented positive electrode material property information into an artificial intelligence model executed by a processor for training; and predicting a doping condition of the positive electrode material using the trained artificial intelligence model executed by the processor, and in the predicting, the predicted positive electrode material doping condition may be derived as at least one of tungsten/zirconium (W/Zr), tungsten/aluminum (W/Al), or tungsten/titanium (W/Ti).

According to yet another embodiment of the invention, a computing system includes: a user computing device and a server computing system performing a task corresponding to instructions or data received from the user computing device. The server computing system may include: a database storing a dataset for training an artificial intelligence model; a memory storing instructions and data for training the artificial intelligence model and performing the task; and at least one processor performing the task according to the instructions or data stored in the memory. The at least one processor may perform operations of receiving an oversampling instruction for the dataset from the user computing device, calculating an oversampling rate for each of data points of the dataset, calculating a sample weight based on the oversampling rate for the data points, oversampling the data points in correspondence to the calculated sample weight, and providing an oversampling result to the user computing device.

Here, the at least one processor may further perform operations of inputting the oversampled dataset to the artificial intelligence model executed by the processor for training, executing a prediction task based on instructions or data received from the user computing device, and providing a prediction task result to the user computing device for output.

The dataset may include a plurality of data points each composed of a feature vector and a target value of the feature vector.

The at least one processor may further perform an operation of calculating an importance score for the data points, wherein the operation of calculating the importance score includes: an operation of calculating a change amount of target values of the data points to calculate the importance score; and an operation of generating oversampling tubular data by selecting some of the data points having a high importance score.

The oversampling rate may be calculated as a rate of number of times that each feature value of a plurality of features included in the data points is duplicated within the dataset divided by a total number of the data points.

The sample weight may be calculated by multiplying a plurality of oversampling rates of the data points and rounding multiplication results.

The data points are replicated as many times as the calculated sample weight and included in a dataset.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the inventive concepts.

FIG. 1 is a schematic diagram illustrating an electronic device according to one embodiment of the invention.

FIG. 2 is a flow chart illustrating an oversampling method according to one embodiment of the invention.

FIG. 3 is a table illustrating an input dataset according to one embodiment of the invention.

FIG. 4 is a schematic diagram illustrating an oversampling process according to one embodiment of the invention.

FIG. 5 and FIG. 6 are tables illustrating results of evaluating an oversampled input dataset according to one embodiment of the invention.

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

As is customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

Artificial intelligence (AI) is a field of computer engineering and information technology that studies methods for enabling a computer to perform thinking, learning, self-development, and the like that may be performed by human intelligence, and refers to enabling a computer to mimic intelligent behavior of humans. Furthermore, AI does not exist by itself, but has many direct and indirect relationships with other fields of computer science. In particular, attempts to introduce AI elements into various fields of information technology and utilize them for solving problems in those fields have been very actively made in modern times.

Machine learning is a field of AI and is a research field that gives computers the ability to learn without explicit programming. Specifically, machine learning may be referred to as a technology for studying and building systems that perform learning and prediction based on empirical data and improve their own performance, and algorithms therefor. Machine learning algorithms take an approach of building specific models to derive predictions or decisions based on input data, rather than performing strictly defined static program instructions.

Many machine learning algorithms have been developed according to how to classify data in machine learning. Representative examples include decision tree, Bayesian network, support vector machine (SVM), and artificial neural network (ANN). A decision tree is an analysis method that performs classification and prediction by plotting decision rules in a tree structure. A Bayesian network is a model that expresses probabilistic relationships (conditional independence) between a plurality of variables in a graph structure. Bayesian networks are suitable for data mining through unsupervised learning. An SVM is a model of supervised learning for pattern recognition and data analysis, and it is mainly used for classification and regression analysis. An ANN is an information processing system in which a plurality of neurons, called nodes or processing elements, are connected in the form of a layer structure by modeling the operating principles of biological neurons and the connection relationships between neurons.

An ANN is a model used in machine learning, and it is a statistical learning algorithm inspired by biological neural networks (particularly brains in the central nervous system of animals) in machine learning and cognitive science. Specifically, an ANN may generally refer to models in which artificial neurons (nodes) forming a network by synaptic connections change the connection strength of synapses through learning to have problem-solving capability. The ANN may be used interchangeably with the term neural network.

An ANN may include a plurality of layers, and each of the layers may include a plurality of neurons. An ANN may also include synapses that connect neurons to neurons. An ANN may generally be defined by the following three factors: \textcircled{1} connection patterns between neurons of different layers, \textcircled{2} a learning process that updates connection weights, and \textcircled{3} an activation function that generates an output value from a weighted sum of inputs received from a previous layer.

ANNs may include network models such as deep neural networks (DNN), recurrent neural networks (RNN), bidirectional recurrent deep neural networks (BRDNN), multilayer perceptrons (MLP), and convolutional neural networks (CNN), but are not limited thereto.

ANNs are classified into single-layer neural networks and multilayer neural networks according to the number of layers. A general single-layer neural network includes an input layer and an output layer. A general multilayer neural network includes an input layer, one or more hidden layers, and an output layer.

The input layer is a layer that receives external data, and the number of neurons in the input layer is equal to the number of input variables. The hidden layer is located between the input layer and the output layer, receives signals from the input layer, extracts features, and transmits them to the output layer. The output layer receives signals from the hidden layer and outputs output values based on the received signals. Input signals between neurons are multiplied by respective connection strengths (weights) and then summed, and when this sum is greater than the neuron's threshold, the neuron is activated and outputs an output value obtained through an activation function.

A deep neural network including a plurality of hidden layers between an input layer and an output layer may be a representative ANN implementing deep learning, which is a type of machine learning technology. Meanwhile, the term “learning” may be used interchangeably with “training.”

The workflow of machine learning consists of a series of processes for collecting data for training and validation, modeling, and training the model, and may include the processes of training data collection, data inspection and exploration, data preprocessing and cleaning, modeling, and training.

### 1. Training Data Collection

The training data applied to training of the learning model of the invention may be generated using data collected from multiple samples. In the invention, at least one or more different types of training datasets may be used to train the learning model, and each training dataset may further include one or more experiment-based results used as functional labels. At least a portion of the training datasets may be used to train the learning model, and another portion may be used to validate the trained learning model.

### 2. Data Inspection and Exploration

Once training data for learning of the learning model is collected, the collected training data may be subjected to inspection and exploration regarding data structure, noise data, and data cleaning methods for machine learning application.

This data inspection and exploration step is referred to as an Exploratory Data Analysis (EDA) step, and EDA may be referred to as a process of observing and understanding collected data from various perspectives. Before learning the data, independent variables, dependent variables, variable types, data types of variables, and the like are inspected through visualization, such as graphs, and statistical tests, and the characteristics of the data and inherent structural relationships may be confirmed in advance. By examining the distribution and values of the data through such EDA, the phenomenon represented by the data can be better understood, and potential problems with the data can be discovered. In addition, through the process of inspecting the data from various perspectives, various patterns that may not have been identified in the problem definition step can be discovered, and based on these, existing hypotheses can be modified or new hypotheses can be established. Exploratory data analysis may broadly include a process of exploring outliers in the data and a process of analyzing relationships between data attributes.

The process of exploring outliers is to check whether outliers are present in the data and may include sampling methods, statistical methods, visualization methods, and the like. The sampling method extracts random samples from the data to confirm overall trends and anomalies in the data values. The statistical method may use summary statistics such as mean, median, and mode for confirming the center of the data, or range and variance for confirming the dispersion of the data. The visualization method may utilize probability density functions, histograms, dot plots, word clouds, time series charts, maps, and the like to determine which statistical indicators are appropriate for individual attributes of the collected data. However, when using statistical indicators, it should be noted that since all data values in the set are reflected in the mean, the mean value is affected when there are outliers, but since one value located in the middle is used as the median, representative results may be obtained even in the presence of outliers.

The process of analyzing relationships between data attributes involves finding combinations of attributes that have meaningful correlations with each other within the data, and the relationship analysis may be performed differently according to attribute combinations between qualitative attributes (categorical variables) that may not be expressed numerically but may be arbitrarily quantified and quantitative attributes (numeric variables) that may be quantified. Qualitative-qualitative relationships (categorical-categorical) may display the number of values corresponding to each pair of attribute values using cross tables and mosaic plots, quantitative-qualitative relationships (numeric-categorical) may be observed through statistical values (mean, median, etc.) for each category or visually represented through box plots. Quantitative-quantitative relationships (numeric-numeric) may analyze the association between two attributes through correlation coefficients. It may be confirmed that a correlation coefficient of −1 indicates a negative correlation where two attributes change in opposite directions, 0 indicates no correlation, and 1 indicates a positive correlation where two attributes always change in the same direction. The relationship between two attributes having a correlation coefficient may also exhibit various patterns, which may be visually represented using scatter plots.

### 3. Data Preprocessing and Cleaning

Data that has completed inspection and exploration undergoes data preprocessing to be processed into a form suitable for models for machine learning. Data preprocessing involves cleaning data and transforming it into a form that may be understood by the model, and data preprocessing may generally include handling missing data, outlier removal, data scaling, categorical data encoding, feature selection and extraction, and data transformation. All or part of the detailed processes of data preprocessing may be selectively performed, and a separate machine learning model may be used for data preprocessing.

Handling missing data is processing missing values when they are present in the data, wherein the missing values may be represented as NaN (Not a Number) or null values or may be deleted. As the missing values are filled or deleted within the data, the completeness of the data is improved, and when filling the missing values, an average value, a median value, a mode value, or the like may be used.

Outlier removal is removing outliers from data, which are values that deviate from typical data patterns. Since outliers may degrade model performance, they must be removed or replaced, and outliers may be identified and corresponding rows or columns may be deleted or replaced with other values.

Data scaling is a process of adjusting the size of data, and the range of data may be adjusted through data scaling so that the performance of the model may be improved or the convergence speed may be enhanced. Through data scaling, the characteristics of the data may be adjusted to a similar range, and generally, standardization and normalization may be applied to data scaling. Standardization is a method of converting data into a distribution with a mean of 0 and a standard deviation of 1, mainly using the mean and the standard deviation for conversion, and the standardized value z may be denoted as z=(x−μ)/c (where x is the original value, u is the mean, and σ is the standard deviation). Normalization is a method of converting the range of data to [0,1] or [−1,1], mainly using the minimum value and the maximum value to transform the data, and the normalized value xₙₒᵣₘ may be denoted as xₙₒᵣₘ (x−xₘᵢₙ)/(xₘₐₓ−xₘᵢₙ) (where x is the original value, xₘᵢₙ is the minimum value, and xₘₐₓ is the maximum value).

Categorical data encoding is converting categorical variables represented by character strings or integer values that may not be directly input to a model into numerical form that may be input to the model. Generally, one-hot encoding or label encoding may be used to convert categorical variables into numerical form.

Feature selection and extraction is for selecting the most useful features for model learning or extracting new features to improve the performance of the model, and through this process, the complexity of the model can be reduced and overfitting can be prevented.

Data transformation is for transforming data to extract new information or enable the model to better understand the data, and it may include tokenization of text data or preprocessing of image data. Through data transformation, useful features may be extracted from original data, or data may be transformed into an appropriate form to improve the performance of the model.

Through the above-described data preprocessing, the effects of improving performance and ensuring stability of the machine learning model can be achieved.

When training the learning model according to one embodiment of the invention, a process of preprocessing information expressed in natural language and a process of training a language model based on the preprocessed data may be performed.

### 3-1. Text Preprocessing for Large Language Models

When the collected data is not preprocessed as needed, tokenization, cleaning, and normalization may be performed according to the intended use of the data.

Tokenization refers to the operation of dividing given data into units called tokens, and the units of tokens may generally be defined as meaningful units. Tokenization may broadly include word tokenization and sentence tokenization.

Word tokenization refers to a case where tokens are based on words, and here the word may include word phrases and character strings having meaning in addition to word units. Word tokenization refers to separating words based on symbols such as spaces or punctuation marks, for example, periods, commas, question marks, semicolons, exclamation marks, and the like. However, when all punctuation marks and special characters are removed during the tokenization operation, tokens may lose their meaning, and thus a precise algorithm for tokenization may be required. For example, when a word itself includes punctuation marks or special characters having meaning are used, the problem may not be solved simply by removing such punctuation marks or special characters. Therefore, tokenization rules such as Penn Treebank Tokenization rules may be applied during tokenization.

Sentence tokenization refers to dividing text into sentence units. Typically, when data has not been cleaned, a corpus is not divided into sentence units, so sentence tokenization may be required to suit the intended use of the corpus. For such sentence tokenization, various rules may be defined depending on the language used and how special characters are used within the corpus.

The operation of classifying tokens according to their intended use is called tokenization, and before and after the tokenization operation, cleaning and normalization are performed on the text data according to the intended use. Cleaning involves removing noise data, and normalization involves integrating words with different representation methods to convert them into the same word.

The cleaning operation may be performed before the tokenization operation to exclude parts that interfere with the tokenization operation, but it may also be continuously and repeatedly performed to remove noise that still remains after the tokenization operation. The noise data removed in the cleaning operation consists of characters that have no meaning, and methods for removing unnecessary words include stop word removal and methods for removing words with low occurrence frequency and short-length words.

The normalization operation includes integration of words with different notations based on rules, uppercase/lowercase integration, and the like. Uppercase/lowercase integration is a normalization method that may reduce the number of words in English-language texts. In English, uppercase letters are used only in specific situations such as at the beginning of sentences, and most text is written in lowercase letters. Therefore, the uppercase/lowercase integration operation may mainly consist of a lowercase conversion operation that converts uppercase letters to lowercase letters.

In order to process natural language in a computing system, a preprocessing operation of converting text into numerical values is required, and to this end, an operation of mapping each word of the text to a unique integer is performed. Such a mapping process may utilize techniques such as integer encoding, padding, and one-hot encoding.

Integer encoding is one method of assigning integers to words, and in this method, a vocabulary in which words are arranged in order of frequency is created, and integers are sequentially assigned from lower numbers in order of highest frequency. Integer encoding performs sentence tokenization from text data including multiple sentences as well as word tokenization in parallel with cleaning and normalization operations. At this time, words are converted to lowercase to standardize the number of words, and words may be deleted based on stop words and word length criteria. Through this process, words may be recorded as keys and the frequency of each word may be recorded as values. After arranging words in the text in order of frequency, integer encoding may be performed by assigning integers to words having high frequency.

Padding is an operation for arbitrarily equalizing the lengths of sentences having different lengths within text. A computing system may bundle sentences having the same length as a single matrix to enable parallel operations. In other words, to perform parallel operations of the computing system, the integer encoding results of sentences having different lengths within the text may be arbitrarily filled with ‘0’ to equalize the lengths of the sentences. In other words, the longest sentence is identified in the word set for which integer encoding has been completed, and “O” may be added to the integer matrix to correspond to the length of the longest sentence. The computing system may recognize sentences having the same length as one matrix to perform parallel processing, wherein the computing system may ignore the “0” word which is recognized as meaningless. Filling data with a specific value to adjust the shape of the data in this manner is called padding, and when the number “0” is used for length adjustment, it is referred to as zero padding.

“One-hot encoding” is a vector representation method for words in which the size of the word set serves as the dimension of the vector, a value of 1 is assigned to the index of the word to be represented, and 0 is assigned to other indices. The vector represented in this manner is called a “one-hot vector”. One-hot encoding includes integer encoding and an index assignment process. After integer encoding is performed to assign a unique integer to each word, the unique integer of the word to be represented is regarded as an index, and “1” is assigned to the corresponding position, while “0” is assigned to the positions of indices of other words. However, one-hot encoding has disadvantages in that the space required to store vectors increases as the number of words increases (increase in vector dimension) and that the similarity between words may not be determined. To overcome these disadvantages, techniques for vectorizing words into a multidimensional space by reflecting the latent meaning of words include count-based vectorization methods such as latent semantic analysis (LSA), prediction-based vectorization methods such as NNLM, RNNLM, Word2Vec and FastText, and the GloVe method which uses both count-based and prediction-based approaches.

In order for computers to understand and process text, the text must be appropriately converted into numbers. Since the performance of natural language processing significantly varies depending on the method of representing words, many technologies for numericalizing words have been proposed. Currently, word embedding methods that vectorize each word through ANN learning are most widely used.

Word embedding is a method of representing words as vectors, converting words into dense representations. The result derived through the word embedding process is called a “dense vector” or “embedding vector”. Word embedding methodologies include LSA, Word2Vec, FastText, GloVe, and the like.

### 4. Modeling and Training

An ANN may be trained using training data. Here, training may refer to a process of determining parameters of the ANN using training data to achieve objectives such as classification, regression analysis, or clustering of input data. Representative examples of parameters of the ANN include weights assigned to synapses and biases applied to neurons.

The ANN trained by training data may classify or cluster input data according to patterns possessed by the input data. An ANN trained using training data may be referred to as a trained model herein.

The following describes methods of training ANNs. Methods of training ANNs may be broadly classified into supervised learning, unsupervised learning, semi-supervised learning, and reinforcement learning.

Supervised learning is a method of machine learning for inferring a function from training data. Among such inferred functions, those that output continuous values are called regression analysis, and those that predict and output the class of input vectors are called classification.

In supervised learning, an ANN is trained with training data for which labels are provided. Here, a label refers to the correct answer (or result value) that the ANN should infer when training data is input to the ANN. Herein, the correct answer (or result value) that the ANN should derive when training data is input is referred to as a label or labeling data. Additionally, herein, setting a label on training data for training of the ANN is referred to as labeling the training data with labeling data. In this case, the training data and the label corresponding to the training data constitute one training set, and they may be input to the ANN in the form of a training set.

The training data represents a plurality of features, and that the training data is labeled with a label may mean that the features represented by the training data are labeled. In this case, the training data may represent the features of the input object in a vector form. The ANN may infer a function for the association relationship between the training data and the labeling data by using the training data and the labeling data. In addition, parameters of the ANN may be determined (optimized) through evaluation of the function inferred by the ANN.

Unsupervised learning is a type of machine learning in which no label is given to the training data. Specifically, unsupervised learning may be a learning method in which an ANN is trained to find and classify patterns in the training data itself, rather than an association relationship between the training data and a label corresponding to the training data. Examples of unsupervised learning include clustering or independent component analysis.

Examples of ANNs using unsupervised learning include a generative adversarial network (GAN) and an autoencoder (AE).

A GAN is a machine learning method in which two different Als, a generator and a discriminator, compete to improve performance. In this case, the generator is a model that creates new data, and it may generate new data based on original data. In addition, the discriminator is a model that recognizes patterns of data, and it may serve to discriminate whether input data is original data or new data generated by the generator. In addition, the generator may receive and learn from data that failed to fool the discriminator, and the discriminator may receive and learn from the data from the generator that fooled the discriminator. Accordingly, the generator may evolve to fool the discriminator as well as possible, and the discriminator may evolve to well distinguish between the original data and the data generated by the generator.

An autoencoder is a neural network that aims to reproduce an input itself as an output. The autoencoder includes an input layer, at least one hidden layer, and an output layer. In this case, since the number of nodes of the hidden layer is less than the number of nodes of the input layer, the dimensions of the data are reduced, and thus compression or encoding is performed. In addition, the data output from the hidden layer enters the output layer. In this case, since the number of nodes of the output layer is greater than the number of nodes of the hidden layer, the dimensions of the data are increased, and thus decompression or decoding is performed.

The autoencoder adjusts the connection strength of neurons through learning, so that the input data is represented as hidden layer data. In the hidden layer, information is represented by a smaller number of neurons than in the input layer, but that the input data may be reproduced as the output may mean that the hidden layer discovers and represents hidden patterns from the input data.

Semi-supervised learning is a type of machine learning, and it may refer to a learning method that uses both training data with a given label and training data without a given label. One technique of semi-supervised learning is inferring a label of training data without a given label and then performing learning using the inferred label, and such a technique may be effectively used when the cost involved in labeling is high.

Reinforcement learning is based on a theory that an agent may find the best way through experience without data, given an environment in which the agent may determine what action to take at every moment. Reinforcement learning may be performed mainly by a Markov Decision Process (MDP). To describe the Markov decision process, first, an environment in which information necessary for the agent to take a next action is configured is given, second, how the agent should act in the environment is defined, third, what the agent does well is rewarded and what it does poorly is penalized, and fourth, an optimal policy is derived through iterative experience until a future reward reaches a maximum point.

The structure of an ANN is specified by the model configuration, activation function, loss function or cost function, learning algorithm, optimization algorithm, and the like, and hyperparameters may be preset before learning, and thereafter model parameters may be set through learning to specify the content.

For example, elements that determine the structure of an ANN may include the number of hidden layers, the number of hidden nodes included in each hidden layer, input feature vectors, target feature vectors, and the like.

The hyperparameter includes various parameters that need to be initially set for learning, such as an initial value of a model parameter. In addition, the model parameter includes various parameters to be determined through learning. For example, the hyperparameters may include an initial value of the weight of the nodes, an initial value of the bias of the nodes, a mini-batch size, a number of learning iterations, a learning rate, and the like. In addition, the model parameters may include a weight of the nodes, a bias of the nodes, and the like.

The loss function may be used as an indicator (criterion) for determining optimal model parameters in the learning process of an ANN. In ANNs, learning refers to a process of manipulating model parameters to reduce the loss function, and the purpose of learning may be viewed as determining model parameters that minimize the loss function. The loss function may mainly use mean squared error (MSE) or cross entropy error (CEE), and the invention is not limited thereto. The CEE may be used when a correct answer label is one-hot encoded. One-hot encoding is an encoding method in which a correct answer label value is set to 1 only for a neuron corresponding to a correct answer, and a correct answer label value is set to 0 for neurons that are not correct answers.

In machine learning or deep learning, a learning optimization algorithm may be used to minimize the loss function. Examples of the learning optimization algorithm include gradient descent (GD), stochastic gradient descent (SGD), Momentum, Nesterov Accelerated Gradient (NAG), Adagrad, AdaDelta, RMSProp, Adam, Nadam, and the like.

GD is a technique of adjusting model parameters in a direction that reduces the loss function value by considering the gradient of the loss function in the current state. The direction in which the model parameters are adjusted is referred to as a “step direction”, and the magnitude of the adjustment is referred to as a “step size”. In this case, the step size may refer to a learning rate. In GD, the gradient may be obtained by partially differentiating the loss function with respect to each model parameter, and the model parameters may be updated by changing them by the learning rate in the obtained gradient direction.

SGD is a technique in which the training data is divided into mini-batches, and GD is performed for each mini-batch to increase the frequency of gradient descent.

Adagrad, AdaDelta, and RMSProp are techniques for adjusting the step size in SGD to increase optimization accuracy. Momentum and NAG in SGD are techniques for adjusting the step direction to increase optimization accuracy. Adam is a technique for adjusting both the step size and the step direction by combining Momentum and RMSProp to increase optimization accuracy. Nadam is a technique for adjusting both the step size and the step direction by combining NAG and RMSProp to increase optimization accuracy.

The learning speed and accuracy of an ANN are greatly dependent on the structure of the ANN and the type of learning optimization algorithm as well as hyperparameters. Therefore, in order to obtain a good learning model, it is important not only to determine an appropriate ANN structure and learning algorithm, but also to set appropriate hyperparameters.

Typically, hyperparameters are experimentally set to various values while training the ANN, and as a result of the training, they are set to optimal values that provide stable learning speed and accuracy.

The embodiments according to the AI system for oversampling input data of one embodiment of the invention and the method thereof may be applied to the field of development of novel materials. In particular, the present embodiments may be applied to the development of manganese-rich (Mn-rich) positive electrode materials that can utilize 60% or more of manganese (Mn), which is a relatively inexpensive material having a structure different from that of existing positive electrode materials applied to batteries. In addition, the embodiments of the invention are also applicable to the field of prediction of structure and physical properties of other structures such as crystal structures, molecular structures, protein structures, catalyst structures, and metal-organic frameworks (MOF). Furthermore, the embodiments of the invention can predict the EC number of a protein having an input amino acid sequence from protein amino acid sequence information input by a user with improved performance and can predict the EC number of the protein having the amino acid sequence input by the user not only at a low level but also at a high level with improved performance compared to the conventional technology.

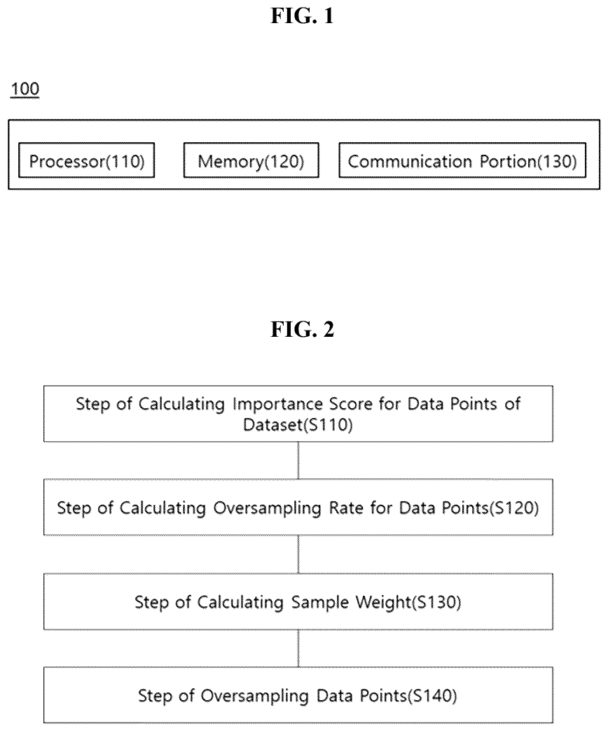

FIG. 1 is a schematic diagram illustrating an electronic device according to one embodiment of the invention.

As shown in FIG. 1, the electronic device 100 according to embodiments of the invention may include a processor 110, a memory 120, and a communication portion 130. The electronic device 100 is a basic component for performing a computing environment, and in other embodiments, the electronic device 100 may be implemented by additionally or alternatively including some other components, may be implemented as a single or plurality of entities, or may be implemented with only some of the disclosed components. At least some of the components inside or outside the electronic device 100 may be connected to each other through a BUS, General Purpose Input/Output (GPIO), Serial Peripheral Interface (SPI), Mobile Industry Processor Interface (MIPI), or the like to transmit and receive data or signals.

The processor 110 may refer to a set of one or more processors unless the context clearly indicates otherwise, and it may control the components of the processor 110 and the electronic device 100 by driving at least software (e.g., instructions, programs, etc.) stored in the memory 120. In addition, the processor 110 may perform various operations such as computations, processing, data generation, or processing, and it may read data from the memory 120 or store data in the memory 120. The processor 110 may be configured with at least one core and may include processors for data analysis, machine learning (ML), or deep learning (DL), such as a central processing unit (CPU), a general purpose graphics processing unit (GPGPU), or a tensor processing unit (TPU). The processor 110 may read software stored in the memory 120 to perform data processing for machine learning (or deep learning) of the invention. According to one embodiment of the invention, the processor 110 may perform computations for training a neural network. The processor 110 may perform calculations for training a neural network, such as processing input data for training in deep learning, feature extraction from the input data, error calculation, and updating weights of the neural network using backpropagation. At least one of the CPU, the GPGPU, and the TPU of the processor 110 may process training of the neural network model. For example, the CPU and the GPGPU may together process training of a neural network model and data classification using the neural network model. In addition, in one embodiment of the invention, at least one processor 110 of the electronic device 100 may be used together to process training of a neural network model and data classification using the neural network model.

The memory 120 is for storing various data, and the data may include software (e.g., instructions, programs, etc.) as data obtained, processed, or used by at least one component of the electronic device 100. The memory 120 may refer to a set of one or more memories unless the context clearly indicates otherwise, and it may include at least one type of storage medium among flash memory type, hard disk type, multimedia card micro type, card type memory (e.g., SD or XD memory, etc.), RAM, SRAM (Static Random Access Memory), ROM, EEPROM (Electrically Erasable Programmable Read-Only Memory), PROM (Programmable Read-Only Memory), magnetic memory, magnetic disk, optical disk, and web storage performing a storage function on the Internet. Instructions, programs, or software stored in the memory 120 may be used to refer to an operating system for controlling components of the electronic device 100, applications, or middleware that provides various functions to applications so that the applications may utilize the components of the electronic device 100. In one embodiment, when the processor 110 performs a specific computation, the memory 120 may store instructions performed by the processor 110 and corresponding to the specific computation.

The communication portion 130 performs wireless or wired communication between the electronic device 100 and another device (e.g., a user terminal or another server). The communication portion 130 may use wireless communication systems according to schemes such as eMBB, URLLC, MMTC, LTE, LTE-A, NR, UMTS, GSM, CDMA, WCDMA, TDMA, FDMA, OFDMA, SCFDMA, WiBro, WiFi, Bluetooth, NFC, GPS, or GNSS. In addition, the communication portion 130 may use various wired communication systems such as USB, HDMI, Recommended Standard-232 (RS-232), Plain Old Telephone Service (POTS), Public Switched Telephone Network (PSTN), x Digital Subscriber Line (xDSL), Rate Adaptive DSL (RADSL), Multi Rate DSL (MDSL), Very High Speed DSL (VDSL), Universal Asymmetric DSL (UADSL), High Bit Rate DSL (HDSL), and Local Area Network (LAN). In one embodiment of the invention, the communication portion 130 may be configured regardless of communication modes such as wired communication and wireless communication, and it may be configured as various communication networks such as a Personal Area Network (PAN), Wide Area Network (WAN), or the like. In addition, the communication network may be a known World Wide Web (WWW), or it may use wireless transmission technology used for short-range communication such as Infrared Data Association (IrDA) or Bluetooth.

The electronic device 100 according to an embodiment of the invention may configure an AI system for oversampling input data or execute software that configures a method thereof.

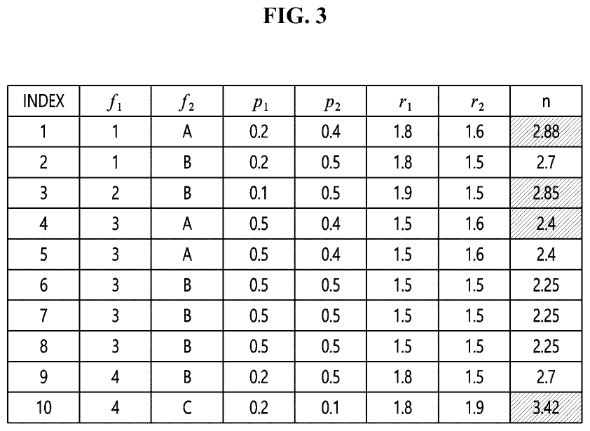

As shown in FIG. 2, an oversampling method of an AI system according to one embodiment of the invention may include: a step of calculating an importance score for data points of a dataset (S110); a step of calculating an oversampling rate for each of the data points (S120); a step of calculating a sample weight based on the oversampling rate for the data points (S130); and a step of oversampling the data points in correspondence to the calculated sample weight (S140).

The tabular data of one embodiment is structured data composed of rows and columns, and each row represents a sample and each column represents a feature. When the tabular data has n rows (samples) and m columns (features), the sample may be denoted as sₙ, and the feature may be denoted as fₘ.

In Step S110 of calculating the importance score for the data points of the dataset, the AI system of one embodiment of the invention may secure tabular data as an input dataset. The AI system of one embodiment is particularly directed to small-scale tabular data including categorical inputs. When an input dataset such as tabular data is referred to as D, D is a set of a plurality of data points,

$$D = {\{ ( {x}_{i} , {y}_{i} ) \}}_{i = 1}^{N} ,$$

where xᵢ is a feature vector (a p-dimensional real vector set), yᵢ is a target value (a real set), and N is a total number of samples (data points) of the input dataset. The system and method of one embodiment may select d important features and apply oversampling according to the frequency of feature values. In one embodiment, a feature of xᵢ of one data point may be referred to as fᵢ, and a feature of yᵢ may be referred to as fⱼ.

For each feature fⱼ of the plurality of data points, a prediction change is calculated, and thereby the importance of each feature may be evaluated. An importance score may be calculated as an average of prediction changes in all samples (data points). The importance score may be calculated by the following equation.

$$Importance ( {f}_{j} ) = \frac{1}{N} {\sum }_{i = 1}^{N} Δ {\hat{y}}_{i}^{( {f}_{j} )} \qquad [ Mathematical Formula 1 ]$$

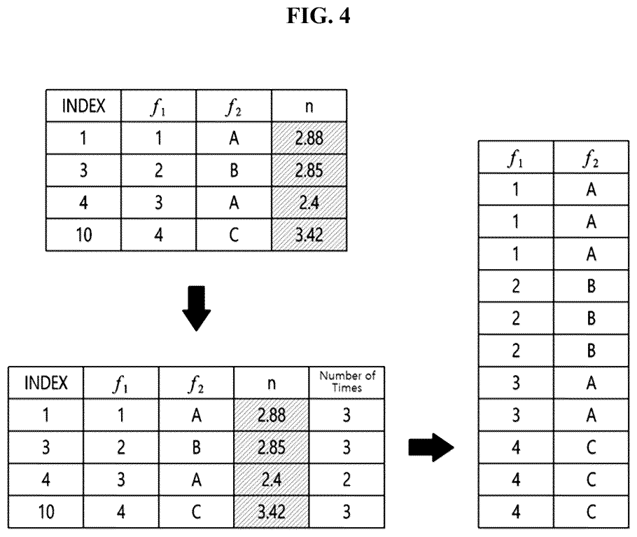

A plurality of top d important features with high importance scores may be selected according to the importance scores, and a set F={f₁, f₂, . . . f_{d}} may be composed of the selected important features. In other words, a feature set for performing oversampling based on data points having the top d important features, i.e., oversampling tabular data, may be generated. Referring to FIG. 3, for feature f₂, oversampling tabular data may be generated in which oversampling is performed by data points including A, B, and C, which are three (d=3) of the important features.

Algorithm

Step 1 : Feature Importance Calculation
Perturb fⱼ and compute prediction changes Δŷi^{(f}^{ⱼ}⁾.
$Calculate Importance ( {f}_{i} ) = \frac{1}{N} \sum i = {1}^{N} Δ {\hat{y}}_{i}^{( {f}_{j} )} .$
Select top d important features to form the set F = {f₁, f₂, ... , f_{d}}

In Step S120 of calculating the oversampling rate of each data point, for each feature of the set F, that is, each feature fᵢ and fⱼ of the oversampling table data, the frequency of the feature value x of each feature, that is, the rate of the number of times the feature value is duplicated in the data, may be calculated. The frequency p(fᵢ=x) of the feature value x may be calculated as the rate of the feature fᵢ in the dataset, and the frequency of the feature fᵢ may be as follows.

$$p ( {f}_{i} = x ) = \frac{count ( {f}_{i} = x )}{N} \qquad [ Mathematical Formula 2 ]$$

Referring to FIG. 3, the dataset selected based on the importance score, that is, the oversampling table data, includes 10 data points (10 rows), and the feature value “3” of the feature f₁ includes 5 of the 10 data points, so the frequency p may be 0.5. “C” of the feature f₂ includes 1 of the 10 data points, so the frequency p may be 0.1.

An oversampling rate r for each feature value may be defined as follows.

$$r ( {f}_{i} = x ) = 1 - p ( {f}_{i} = x ) \qquad [ Mathematical Formula 3 ]$$

Algorithm

```
Step 2: Feature Frequency Rate Calculation
for each feature fⱼ in F do
    for each unique value x of fⱼ do
        $Compute the frequency p ( {f}_{i} = x ) = \frac{count ( {f}_{i} = x )}{N}$
        Calculate the oversampling rate r(fᵢ = x) = 1 − p(fᵢ = x)
    end for
end for
```

Referring to FIG. 3, “1” of the feature f₁ has a calculated oversampling rate of 0.8 and then 1 is added thereto, so that the oversampling rate (r₁) is finally calculated to be 1.8. Similarly, “A” of the feature f₂ has a calculated oversampling rate of 0.6 and then 1 is added thereto, so that the oversampling rate (r₂) is finally calculated to be 1.6.

In Step S130 of calculating the sample weight based on the oversampling rate for the data points, the oversampling rate may be used to calculate the number of times each data point should be sampled. For each data point xᵢ, the sample weight nₛₐₘₚₗₑ(xᵢ) may be calculated by multiplying the oversampling rates of the values of the selected features. The sample weight for the data points may be calculated as follows.

$${n}_{sample} ( {x}_{i} ) = {\prod }_{{f}_{j} ∈ F} ( 1 + r ( {F}_{j} {=}_{{X}_{i , j}} ) ) \qquad [ Mathematical Formula 4 ]$$

Referring to FIG. 3, a sample weight n is calculated by multiplying the oversampling rates r₁ and r₂ of features f₁ and f₂ for each data point in the input dataset. For example, a sample weight n=2.88 may be calculated by multiplying r₁ 1.8 and r₂ 1.6 of data point x₁.

The sample weight thus calculated determines the number of times the feature fiis duplicated, and for this purpose, the sample weight is rounded.

[Algorithm]

Step 3 : Calculate Overall Sample Weight
for each data point xᵢ do
Initialize nₛₐₘₚₗₑ(xᵢ)=1
for each feature fⱼ in F do
nₛₐₘₚₗₑ(xᵢ)←nₛₐₘₚₗₑ(xᵢ) × (1+r(fⱼ=x_{i,j})
end for
nₛₐₘₚₗₑ(xᵢ)←round(nₛₐₘₚₗₑ(xᵢ))
end for

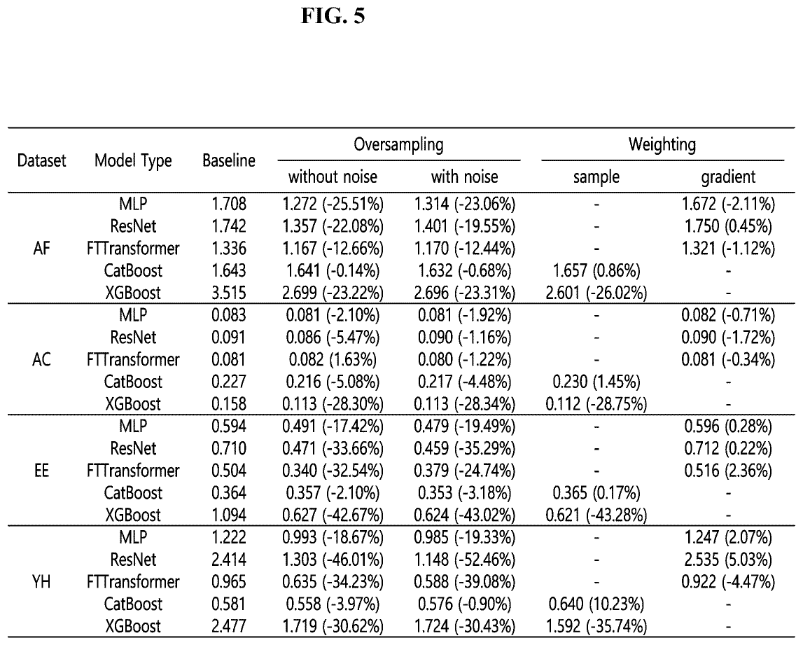

In Step S140 of oversampling by replicating the data points in correspondence to the calculated sample weight, a data point to be replicated may be selected based on the magnitude of the sample weight and replicated as many times as the sample weight value. Referring to FIG. 3, among data points having the same feature f₁, a data point having the highest sample weight may be selected as a target to be duplicated. For example, since data point 1 (1, A) has a sample weight of 2.88 and data point 2 (1, B) has a sample weight of 2.7, data point 1 may be selected as a target to be replicated. In one embodiment of the invention, the target to be replicated is selected based on the feature f₁ of each data point. However, alternatively, the magnitudes of the sample weights among data points having the same feature may be compared based on the feature f₂, and the data point having the largest value may be selected. Referring to FIG. 4, data points 1, 3, 4, and 10 selected as targets to be replicated may have their sample weights rounded to determine the number of times to be replicated. The sample weight 2.88 of data point 1 is rounded to 3, and accordingly, data point 1 may be replicated by a total of three.

Algorithm

```
Step 4 : Data Oversampling
for each data point xᵢ do
for t = 1 to nₛₐₘₚₗₑ(xᵢ) do
    $Create duplicate {x}_{i}^{( t )} ← {x}_{i}$
    Calculate combined standard deviation:
        σ_{combined} = k \sqrt{Σ_{j = 1}^{d} σ(fⱼ = x_{i,j})²}
    $Sample noise {∈}^{ε \sim N ( 0 , {σ}_{com bined}^{2} )}$
    $Set {y}_{i}^{( t )} ← {y}_{i} + ε$
    $Add ( {x}_{i}^{( t )} , {y}_{i}^{( t )} ) to the augmented dataset {D}^{′}$
end for
end for
```

In another embodiment of the invention, the method may further including a Step S150 (not shown) of adding noise to the replicated data points.

To introduce variation to the replicated samples, that is, the oversampled dataset, Gaussian noise ε may be added to the target value yᵢ. The noise may be extracted from a normal distribution

$$N ( o , {σ}_{combined}^{2} ) ,$$

and here, it may be calculated as a combined standard deviation

$${( {σ}_{combined}^{2} )}^{{c}_{combined}} = k \sqrt{{\sum }_{j = 1}^{d} {σ ( {f}_{j} = {x}_{i , j} )}^{2}}$$

(k is a scaling factor that adjusts the magnitude of the noise). Through this Step S150, a new target value for each replicated sample becomes

$${y}_{i}^{( t )} = {y}_{i} + ε ,$$

and the generated data points may be added to the augmented dataset. By adding noise to such an input dataset, overfitting of the existing model may be reduced, and generalization performance may be improved.

The AI system and oversampling method of the above-described embodiments of the invention can effectively process categorical variables by preserving the original feature values during the oversampling process of the tabular input dataset and can maintain data integrity without complex encoding or synthesis and generation of categorical data.

To evaluate the performance of the AI system and oversampling method of these embodiments of the invention, tabular datasets applied to regression analysis may be used. The small-scale datasets used for performance evaluation of the embodiments include: \textcircled{1} Analyzing Categorical dataset (AC), \textcircled{2} Airfoil dataset (AF), \textcircled{3} Energy Efficiency dataset (EE), and \textcircled{4} Yacht Hydrodynamics dataset (YH).

The AC dataset contains 4,052 samples and 7 features. The AC data is a categorical analysis dataset used in the book Analyzing Categorical Data and includes various datasets for scientific and educational purposes. The AF dataset is data produced by NASA and contains 1,503 samples and 4 features related to airfoil performance including frequency, angle of attack, and velocity. This dataset is commonly used for airfoil noise prediction studies. The EE dataset is used for energy efficiency prediction studies based on building features such as glass area and orientation, and this dataset contains 768 samples and 8 features. The YH dataset contains 380 samples and 6 features related to yacht hydrodynamics including hull shape and Froude number. This dataset is used for studies predicting residual resistance per unit weight in various yacht designs.

The oversampling method of the embodiments was applied to the four datasets to augment the datasets, and three deep learning models and two machine learning models were employed to evaluate the augmented datasets. The deep learning models may include MLP, ResNet, and FTTransformer, and the machine learning models may include CatBoost and XGBoost. The oversampling rate (r) was used as a sample weight in the machine learning models and as a gradient weight in the deep learning models. In the deep learning models, the oversampling rate may be included in the gradient of the loss function with respect to the model parameter θ.

$${∇}_{θ} L ( θ ) = \frac{1}{N} {\sum }_{i = 1}^{N} \frac{{r}_{i}}{{r}_{min}} \cdot {∇}_{θ} {( {\hat{y}}_{i} - {y}_{i} )}^{2}$$

This may mean that the gradient of each data point is scaled by the corresponding ratio

$$\frac{{r}_{i}}{{r}_{min}} .$$

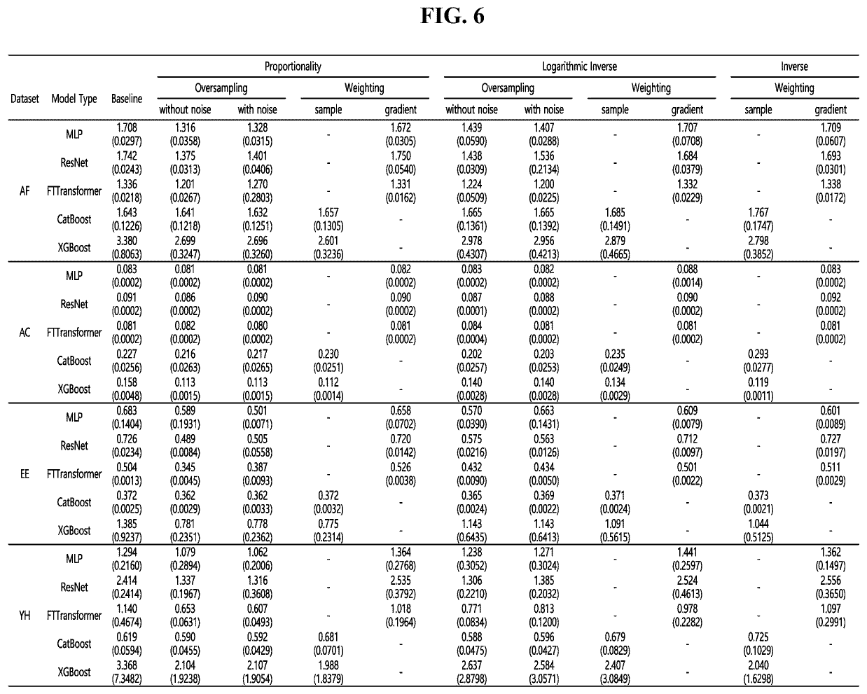

Referring to FIG. 5, a baseline was determined by optimizing hyperparameters of deep learning models and machine learning models using the original input dataset prior to oversampling, and evaluation was performed by inputting a dataset to which the oversampling method of the embodiments of the invention was applied to the optimized models. In the evaluation, the scaling factor k was set to 0.01, and the number of important features d was set to 3, with 10 evaluations performed. As a result of calculating the average root mean square deviation (RMSE) for 10 training runs, the oversampled dataset according to the embodiments of the invention showed high performance improvement compared to conventional weighting methods. In particular, higher performance improvement was shown in small-scale datasets with fewer than 1,000 samples, specifically the EE and YH datasets. The oversampled EE dataset reduced the RMSE by 43.02% compared to the baseline in the XGBoost model, and the oversampled YH dataset reduced the RMSE by 52.46% compared to the baseline in the ResNet model, demonstrating very high performance improvement.

Referring to FIG. 6, additional evaluation was performed on the embodiments of the invention. In one embodiment, the oversampling rate r is determined as r=1−p (Proportionality). To evaluate the performance of the oversampling rate of this embodiment, a dataset was constructed by modifying the oversampling rate, and performance evaluation was performed. The modification of the oversampling rate included inverse and logarithmic inverse calculations of the oversampling rate (inverse:

$$r = \frac{1}{p + ε} ,$$

logarithmic inverse:

$$r = log ( \frac{1}{p + ε} ) ) .$$

As a result of calculating the average RMSE (root mean square deviation) for 10 training runs, it was confirmed that the oversampled results (Proportionality) according to the embodiments of the invention showed high performance improvement compared to the results of inverse and logarithmic inverse calculations of the oversampling rate.

According to the AI system and oversampling method of the above-described embodiments of the invention, greatly improved performance was derived from the input dataset improved by the oversampling method of the embodiments in the regression analysis tasks using small-scale tabular datasets including categorical inputs. These embodiments can provide practical alternatives in fields such as medicine, finance, and manufacturing, and better prediction accuracy can be derived by enhancing the learning process based on the embodiments.

In addition, the embodiments of the invention can also be applied to research and development of battery component materials such as manganese-rich positive electrode materials. The applicant of the invention applied the data augmentation (oversampling) technique of the embodiments to compensate for the disadvantages of factor-biased data in a manganese-rich positive electrode material mass production project (HERO candidate project, “Acceleration of Mn-rich Positive Electrode Material Development”). By using the oversampling method of the embodiments, two improved candidates compared to the reference sample were derived in monocell (basic battery unit composed of a monolayer of a positive electrode and a negative electrode) experiments among the composite doping conditions designed by AI. The possibility and effectiveness of AI-based positive electrode material development based on the embodiments could be verified.

One embodiment of the invention can be applied to a new positive electrode material prediction system based on an AI model. In other words, one embodiment can be applied to a system that learns positive electrode material data including doping elements using an AI model to predict new positive electrode materials and can be applied to oversampling datasets.

Positive electrode materials are materials that form the positive electrode of secondary batteries, and they are key materials affecting the energy density, output, lifetime, stability, and other characteristics of batteries. The main materials constituting positive electrode materials include positive electrode active materials composed of combinations of lithium (Li) and metal components, and the main components of positive electrode active materials include nickel (Ni), cobalt (Co), manganese (Mn), aluminum (Al), and others. Among these positive electrode active materials, positive electrode materials that reduce the content of expensive nickel and increase the proportion of manganese, namely manganese-rich (Mn-rich) positive electrode materials, are drawing attention as next-generation materials, and research on them is being actively carried out. Manganese-rich positive electrode materials have problems of low lithium ion diffusion rate and conductivity as well as manganese elution during charging and discharging, and coating and doping methods are introduced to solve these problems. Coating is a method of improving lithium ion rate inside and outside the active material, and doping is a method of improving the rate of lithium ions and electrons inside the active material. Doping elements for positive electrode material doping may include aluminum (Al), zirconium (Zr), magnesium (Mg), titanium (Ti), boron (B), fluorine (F), tungsten (W), molybdenum (Mo), gallium (Ga), Nitrogen Group (Va), calcium (Ca), and the like.

Training data applied to training of the AI model according to one embodiment may include feature information of positive electrode materials. For example, the feature information of positive electrode materials may include analytical information including capacity and voltage during charging and discharging, X-ray diffraction (XRD) and particle size distribution of calcined products, and battery performance information including capacity, capacity retention, resistance increase, and gas generation. However, the feature information of positive electrode materials is not limited thereto and may include all information that may distinguish differences between materials.

The oversampling method of the AI system according to one embodiment of the invention may augment datasets used in training AI models through oversampling. One embodiment of the invention may augment positive electrode material datasets through oversampling by calculating oversampling rates for each data point of positive electrode materials, calculating sample weights based on the oversampling rates for the data points, and oversampling data points in correspondence to the calculated sample weights. In one embodiment, data points may be oversampled targeting only doping elements among positive electrode materials. For example, when doping elements including Co, Al, Nb, Mo, Ti, Zr, W, Mg, B, V, and others are included in the positive electrode material dataset, by calculating oversampling rates and sample weights for each of these doping elements and oversampling element feature information, the prediction performance of AI models trained based on this can be improved.

A computerized method for predicting a positive electrode material according to an embodiment of the invention may include: a step of inputting data-augmented positive electrode material information into an AI model executed by a processor for training; and a step of predicting doping conditions of the positive electrode material using the trained AI model executed by at least one processor.

Based on the positive electrode material and doping conditions derived according to the AI model-based new positive electrode material prediction system of one embodiment, an evolution algorithm-based positive electrode material may be designed based on capacity and capacity retention. As a result of conducting coin cell experiments (coin-shaped batteries for positive electrode material evaluation) on candidate positive electrode materials designed according to one embodiment, samples exhibiting high performance in capacity/charge-discharge rate/capacity retention may be derived. When the reference sample for the experiment was set as tungsten (W), the derived samples were tungsten/zirconium (W/Zr), tungsten/aluminum (W/Al), and tungsten/titanium (W/Ti).

Through monocell experiments (basic battery unit composed of a monolayer of a positive electrode and a negative electrode) on three samples derived from the coin cell experiments, two composite doped samples, specifically tungsten/zirconium (W/Zr) and tungsten/aluminum (W/Al), demonstrated superiority over the reference sample in high-temperature (45° C.) capacity retention performance, as shown in Table 1 below.

TABLE 1

| | 0 cycle | | 100 cycle | | 200 cycle | |
|---|---|---|---|---|---|---|
| | Capacity | | Capacity | | Capacity | |
| | retention | Capacity | retention | Capacity | retention | Capacity |
| Classification | (%) | (mAh/g) | (%) | (mAh/g) | (%) | (mAh/g) |
| Tungsten (W) Ref. | 100.0 | 31.3 | 90.3 | 28.2 | 86.0 | 26.9 |
| Tungsten/Zirconium (W/Zr) | 100.0 | 29.9 | 92.3 | 27.6 | 89.5 | 26.7 |
| Tungsten/Aluminum (W/Al) | 100.0 | 30.0 | 91.5 | 27.5 | 88.9 | 26.7 |
| Tungsten/Titanium (W/Ti) | 100.0 | 31.3 | 88.6 | 27.7 | 84.9 | 26.6 |

Tungsten/zirconium (W/Zr) exhibited a capacity retention of 92.3% in the 100-cycle monocell experiment and a capacity retention of 89.5% in the 200-cycle experiment, confirming improved performance compared to the reference. Additionally, tungsten/aluminum (W/Al) exhibited a capacity retention of 91.5% in the 100-cycle monocell experiment and a capacity retention of 88.9% in the 200-cycle experiment, confirming improved performance compared to the reference. In contrast, among the samples, tungsten/titanium (W/Ti) was confirmed to exhibit comparatively inferior performance compared to the reference in the monocell experiment.

In one embodiment of the invention, for developing a novel positive electrode material, a training dataset may be constructed by oversampling a dataset including positive electrode materials and doping elements, and positive electrode composite doping samples may be derived through an AI model trained based thereon, and the performance of the derived samples may be verified through coin cell and monocell experiments. In other words, the novel positive electrode material prediction system and the method of one embodiment of the invention can provide results with high prediction reliability even for the novel manganese-rich positive electrode materials.

One embodiment of the invention may be applied to a protein function prediction system capable of predicting the function of proteins for which EC numbers are not present in the training set. In other words, one embodiment may be applied to oversampling a dataset in a system that predicts EC numbers from amino acid sequences of enzymes using an AI model.

A protein is designated by one or more amino acid sequences, and amino acids are organic compounds include amino functional groups and carboxyl functional groups, as well as side-chains (i.e., atomic groups) specific to the amino acid. Protein folding refers to a physical process by which an amino acid sequence folds into a three-dimensional structure. The structure of a protein defines the three-dimensional arrangement of atoms in the amino acid sequence of the protein after the protein undergoes protein folding. In a sequence connected by peptide bonds, amino acids may be referred to as amino acid residues.

Enzymes are biocatalysts that increase the rate of metabolism by binding with substrates to form enzyme-substrate complexes, thereby lowering the activation energy of chemical reactions. In some cases, they also perform bioprotective functions that regulate reaction rates. Enzymes convert substrates into other molecules known as products. Like other catalysts, enzymes increase reaction rates by lowering the activation energy of chemical reactions. Some enzymes may cause the conversion of substrates to products to occur millions of times faster.

Enzymes are known to catalyze thousands of types of biochemical reactions. Most enzymes are proteins, but some enzymes are RNA molecules having catalytic function. RNA having catalytic function is called ribozyme. The specificity of enzymes derives from their unique three-dimensional structure.

Enzymes are classified according to the numbering system of the Enzyme Commission (EC). The EC numbering system is a hierarchical classification system that classifies enzymes based on the reactions they catalyze, and it includes four levels describing enzyme function. Predicting the EC number of an enzyme protein is used to identify and classify the catalytic activity of that enzyme protein, which may be considered an important task that serves as a foundation for drug discovery and other protein- or enzyme-related applications.

The EC number hierarchical system is a numerical classification system for classifying enzyme proteins according to the chemical reactions catalyzed by the enzyme proteins. The EC number designates an enzyme-catalyzed reaction, and when different enzymes catalyze the same reaction, they are assigned the same EC number. Even when completely different protein foldings catalyze the same reaction through convergent evolution, the same EC number is assigned. Therefore, the function of an enzyme may be determined using the EC number of the protein enzyme.

All EC numbers consist of the letters “EC” followed by four digits separated by periods. The first digit following the EC letters is referred to as the first level, followed by the second through fourth levels. The four levels form a hierarchical structure, with the first level being the highest level and the fourth level being the most subdivided lower level.

The training data applied to the training of an AI model according to one embodiment may include feature information of enzymes. For example, the feature information of enzymes includes amino acid of proteins, sequences, functions, structures, post-translational regulation, EC numbers of enzymes, and the like, and such feature information may be obtained from databases provided by the National Center for Biotechnology Information (NCBI) maintained by the National Institutes of Health, UniProt Knowledge Base (UniProtKB) and Swiss-Prot database provided by the Swiss Institute of Bioinformatics, and the like. However, the feature information of enzymes is not limited thereto and may include all information capable of distinguishing differences between enzymes. In addition, in some cases, multiple samples may be collected from enzymes associated with input data to be processed by the trained model.

The oversampling method of the AI system according to one embodiment of the invention may augment a dataset used for training an AI model by oversampling with respect to multiple collected samples. One embodiment of the invention calculates an oversampling rate for each of data points including protein or enzyme features, calculates sample weights based on the oversampling rates for the data points, and oversamples the data points in correspondence to the calculated sample weights, thereby augmenting the protein or enzyme dataset by oversampling. An AI model may be trained based on the dataset augmented in this way.

A computerized method for predicting protein function according to one embodiment of the invention may include: a step of inputting data-augmented protein amino acid sequence information into an AI model executed by a processor; and a step of predicting an EC number of a protein having the protein amino acid sequence information using the AI model trained by hierarchical contrastive learning executed by at least one processor.

Here, the hierarchical contrastive learning means that training is performed using a training dataset including training data having no information for one or more EC number hierarchical levels and that the trained model predicts an EC number at a level one step higher than the EC number hierarchical level having no information. In this case, the hierarchical contrastive learning may be performed by converting a feature vector of an amino acid sequence of a protein into a representation vector using a multilayer perceptron having three hidden layers.

Hierarchical contrastive learning according to one embodiment may be performed by: (i) using representations of all dimensions when calculating loss at the lowest level, and calculating loss using some dimensions of the representation used at lower levels as moving to higher levels; (ii) using only representations of some dimensions when calculating loss for each level, while some of the dimensions used for each level are used such that they are also used when calculating loss for other levels; (iii) dividing and using dimensions such that dimensions used for each level do not overlap; (iv) setting trainable coefficient vectors having the same size as representation vectors in a number equal to the number of levels, and using values obtained by multiplying representations by coefficient vectors of each level when calculating loss; (v) providing multilayer perceptrons in a number equal to the number of levels; or a combination of the above.

One or more AI models included in the system of the invention may infer an EC number of a query protein from the query protein. The inference is performed based on a distance between the query protein and the EC number.

The inference may include: obtaining embeddings of each EC number from EC numbers in a training dataset; using Euclidean distances between EC number embeddings and query protein embeddings for inference; assuming that an enzyme belongs to a corresponding parent EC number when it belongs to a specific child EC number; using a shortest distance from a child EC number as a distance from a parent EC number; and applying a maximum separation method to binarize labels according to distance.

In one embodiment of the invention, the system and method for predicting protein function may be used to predict functions of completely new enzyme proteins for which EC numbers have not been previously defined. When there is no information about EC numbers, it is impossible to predict EC numbers at level 4 of the lowest hierarchy, but EC numbers at level 3, which is one step higher, may be predicted.

In one embodiment of the invention, hierarchical contrastive learning may be performed using a training dataset including training data having no information about one or more EC number hierarchical levels, and the trained model may predict an EC number at a level one step higher than the EC number hierarchical level having no information with high confidence.

According to one embodiment of the invention, a higher level of EC number may be predicted with improved performance even for a protein enzyme having an EC number that is not included in the training dataset. In other word, the protein function prediction system and method of one embodiment of the invention can provide results with high prediction reliability even for new proteins.

A computing system according to one embodiment of the invention includes a user computing device and a server computing system, and each device and system may be communicatively connected through a communication portion.

The user computing device of one embodiment may perform a process of training an AI model, retraining a model, or predicting or inferring a feature of a target (protein feature, material feature) using an AI model embedded in the device or an AI model provided by a server computing system. In addition, the server computing device may provide a service of predicting a target feature to the user computing device on an application or the web according to a request of the user through the user computing device.

The user computing device may include all types of computing devices such as wearable devices including smartphones, tablet PCs, and the like, and desktop computers. Such user computing devices include at least one processor and a memory. The memory may include one or more non-transitory/transitory computer-readable storage media and combinations thereof and may include a web storage of a server that performs a storage function of the memory on the Internet. Such memory may store data and instructions necessary for the at least one processor to perform operations of an application for training/retraining an AI model or performing target feature prediction.

In addition, the user computing device may store at least one AI models. For example, the user computing device may store machine learning models, such as a plurality of neural networks, and other types of machine learning models including linear/nonlinear models. In addition, the user computing device may store a prompt template as an input means to be used in a process of performing retraining of an AI model or target feature prediction. In other word, in one embodiment, the user computing device may perform target prediction based on data received by requesting performance through a prompt in a process of retraining or fine-tuning of a model or target feature prediction. In addition, for a task requested through the user computing device, a process corresponding to the requested task may be performed through an AI model in which a server computing system is embedded, and a result of the performance may be transferred to the user computing device. Such a user computing device may include at least one user input portion that detects input of the user. For example, the user input portion may include a touch screen that detects touch of an input medium (for example, a finger or a stylus) of the user, an image sensor that detects motion input of the user, a microphone that detects voice input of the user, a button, a mouse, and a keyboard.

The server computing system may include at least one or more processors and a memory, and the at least one or more processors may be include at least one or a plurality of electrically connected processors among a central processing unit (CPU), a graphics processing unit (GPU), application specific integrated circuits (ASICs), digital signal processors (DSPs), digital signal processing devices (DSPDs), programmable logic devices (PLDs), field programmable gate arrays (FPGAs), controllers, micro-controllers, microprocessors, and/or electrical units for performing other functions.

The memory may include one or more non-transitory/transitory computer-readable storage media and combinations thereof. The memory may store an AI model, data, and instructions for the at least one processor to train/retrain the AI model or perform target feature prediction. The memory may store a neural network or a linear/nonlinear model and may include a feed-forward neural network, a deep neural network, a recurrent neural network, a convolutional neural network, and the like. In one embodiment, the server computing system may further include a database that is a storage for continuously storing and managing raw data serving as a basis for training of the AI model, augmentation data (oversampling data) for improving prediction performance of the AI model, and the like. Such databases may include various forms of storage, including file systems and cloud storage. For example, the database may include at least one of: a relational database that uses a structured query language (SQL) to define and manipulate data; a NoSQL database that is designed for flexibility and scalability to process unstructured and semi-structured data; a data warehouse, which is a system used for reporting and data analysis that centralizes large volumes of data from multiple sources and is optimized for querying and analysis; a data lake that stores large amounts of raw data in the basic formats of structured data, semi-structured data, and unstructured data; and a local storage device or Network Attached Storage (NAS) that stores data in a file in a format that is generally accessible by a computer operating system.

The communication portion performs wireless or wired communication between the user computing device and the server computing system. The communication portion may use wireless communication systems according to eMBB, URLLC, MMTC, LTE, LTE-A, NR, UMTS, GSM, CDMA, WCDMA, TDMA, FDMA, OFDMA, SCFDMA, WiBro, WiFi, Bluetooth, NFC, GPS, GNSS, or the like. In addition, the communication portion may use various wired communication systems such as USB, HDMI, Recommended Standard-232 (RS-232), Plain Old Telephone Service (POTS), Public Switched Telephone Network (PSTN), x Digital Subscriber Line (xDSL), Rate Adaptive DSL (RADSL), Multi Rate DSL (MDSL), Very High Speed DSL (VDSL), Universal Asymmetric DSL (UADSL), High Bit Rate DSL (HDSL), and Local Area Network (LAN). In one embodiment, the communication portion may be configured regardless of its communication mode, such as wired and wireless, and may be configured with various communication networks such as a Personal Area Network (PAN) and a Wide Area Network (WAN). In addition, the communication network may be the known World Wide Web (WWW) and may use wireless transmission technology used for short-range communication such as Infrared Data Association (IrDA) or Bluetooth.

The computing system of one embodiment may perform material property prediction, protein information prediction, and the like by utilizing the AI model trained in the server computing system through the user computing device. In addition, the computing system of one embodiment may augment and enhance the dataset of the AI model through the user computing device or through the server computing system to improve the performance of the trained AI model.

In order to oversample the dataset of the server computing system through the user computing device, one embodiment of the invention may calculate an oversampling rate for each data point of the dataset, calculate a sample weight based on the oversampling rate for the data points, and transmit an instruction for oversampling the data points in correspondence to the calculated sample weight to the server computing system. An enhanced oversampling dataset is generated from an existing dataset of the server computing system through the instruction of the user computing device, and as the generated oversampling dataset is included in the existing dataset, the performance of protein feature prediction or positive electrode material or positive electrode material doping condition prediction may be further improved.

In addition, one embodiment of the invention may augment the dataset applied to the AI model of the server computing system using the AI model of the user computing device and then transfer the augmented oversampling dataset or the training dataset including the augmented oversampling dataset to the server computing system, thereby improving the performance of the AI model of the server computing system.

A computerized method for predicting a positive electrode material according to one embodiment of the invention may include: a step of inputting data-augmented positive electrode material information into an AI model executed by a processor for training; and a step of predicting doping conditions of the positive electrode material using the trained AI model executed by at least one processor.

One embodiment of the invention may be implemented as an application-specific integrated circuit (ASIC) that is manufactured to suit the specific functions of particular application fields and devices.

ASICs are also referred to as custom semiconductors. Unlike standard semiconductors that have specified standards and is applicable to any electronic product or application when certain requirements are met, ASICs are integrated circuits manufactured by semiconductor manufacturers according to specific orders for use in specific products or functions. In other words, custom semiconductors are designed and manufactured to perform only the functions necessary for specific devices or specific functions. Custom semiconductors are broadly divided into full custom ICs, in which circuits are designed and manufactured from the beginning according to user requirements based on design methods, and semi-custom ICs, in which circuits are designed and manufactured using part of standardized designs.

Custom semiconductors are mainly used in communication systems, high-performance computing systems, consumer electronics, automobiles, industrial automation, medical devices, military, aerospace industry, and the like. Recently, they have been applied to AI semiconductors that execute large-scale computations required for AI implementation with high performance and power efficiency.

ASICs are used as key components of, for example, network routers, switches, and modems in communication systems to perform data packet processing, protocol conversion, signal processing, and the like, thereby providing high throughput and low latency. In high-performance computing systems, ASICs are used as key components for high-speed processing and parallel processing, and in consumer electronics such as digital cameras, smartphones, tablets, and game consoles, ASICs provide the high-performance and low-power solutions required to perform specific functions. In the automotive industry, ASICs are used to control various electronic systems within automobiles, and in industrial automation systems, ASICs provide solutions for high-precision control and high-performance processing.

ASICs to which one embodiment of the invention is applied may include a memory in which an individual memory interface (I/F) is implemented and may include a plurality of functional blocks that request memory access. Each functional block may be a direct memory access (DMA) functional block, a processor, a video processor, a cache controller, a decompression block, or a data path block. The basic configuration of the ASICs may include transistors that amplify or switch electrical signals, logic gates that are circuits performing logical functions by combining transistors, memory cells that store data, analog circuits that are circuits processing continuous voltage or current by combining transistors, microprocessors that are pre-designed to perform specific functions, DSPs, IP cores (Intellectual Property Cores) such as graphics cores, and the like.

The ASICs may also include an individual memory I/F that interfaces with individual memory and an embedded memory I/F that interfaces with embedded memory, and the individual memory I/F may be connected to each functional block to receive memory access signals (e.g., control signals, address signals, and data signals) and generate signals for controlling the individual memory based on these input signals. The embedded memory I/F may be connected to each functional block to receive memory access signals (e.g., control signals, address signals, data signals) and generate modified memory access signals for controlling the embedded memory based on these input signals. The individual memory I/F and the embedded memory I/F are designed within a memory control block of the ASIC to provide a memory control structure that may be flexibly applied to both individual memory and embedded memory.

In addition, an ASIC for an ANN includes a plurality of neurons arranged in an array and a plurality of synaptic circuits, and each neuron may include a register, a microprocessor, and at least one input, and each synaptic circuit may include a memory for storing synaptic weights. Here, each neuron of the ASIC may be connected to at least one other neuron through one of the plurality of synaptic circuits.

Although the invention has been described above as generally being implementable by a computing device, those skilled in the art will appreciate that the invention may be implemented in combination with computer-executable instructions and/or other program modules executable on one or more computers and/or as a combination of hardware and software.

Those skilled in the art will understand that information and signals may be represented using any of a variety of different technologies and techniques. For example, data, instructions, commands, information, signals, bits, symbols, and chips that may be referenced in the above description may be represented by voltages, currents, electromagnetic waves, magnetic fields or particles, optical fields or particles, or any combination thereof.

Those skilled in the art will appreciate that the various exemplary logical blocks, modules, processors, means, circuits, and algorithm steps described in connection with the embodiments disclosed herein may be implemented by electronic hardware, various forms of program or design code (referred to herein as software for convenience), or combinations of both. To clearly describe this interchangeability of hardware and software, various illustrative components, blocks, modules, circuits, and steps have been described above generally in terms of their functionality. Whether such functionality is implemented as hardware or software depends upon the particular application and design constraints imposed on the overall system. Those skilled in the art may implement the described functionality in varying ways for each particular application, but such implementation decisions should not be interpreted as departing from the scope of the invention.

The various embodiments presented herein may be implemented as a method, apparatus, or article of manufacture using standard programming and/or engineering techniques. The term “article of manufacture” includes a computer program, carrier, or media accessible from any computer-readable storage device. For example, computer-readable storage media include magnetic storage devices (e.g., hard disks, floppy disks, magnetic strips, etc.), optical disks (e.g., CDs, DVDs, etc.), smart cards, and flash memory devices (e.g., EEPROMs, cards, sticks, key drives, etc.), but are not limited thereto. In addition, the various storage media presented herein include one or more devices and/or other machine-readable media for storing information.

According to an embodiment of the invention, performance of an artificial intelligence (AI) system can be improved even with small-scale tabular input data by dynamically determining an oversampling rate based on characteristic distribution of input data. It should be understood that the specific order or hierarchy of steps in the processes presented is an example of exemplary approaches. It should be understood that, based on design priorities, the specific order or hierarchy of steps in the processes may be rearranged within the scope of the invention. The accompanying method claims present elements of various steps in a sample order, but are not meant to be limited to the specific order or hierarchy presented.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A system comprising:
at least one processor; and
at least one memory storing instructions or information executed by the at least one processor,
wherein operations performed by the instructions or information executed by the at least one processor include:
an operation of calculating an oversampling rate for each of data points of a dataset;
an operation of calculating a sample weight based on the oversampling rate for the data points; and
an operation of oversampling the data points in correspondence to the calculated sample weight.

2. The system of claim 1, wherein the dataset includes a plurality of data points each composed of a feature vector and a target value of the feature vector.

3. The system of claim 1, further comprising an operation of calculating an importance score for the data points, wherein the operation of calculating the importance score includes:
an operation of calculating a change amount of target values of the data points to calculate an importance score; and
an operation of generating oversampling tubular data by selecting some of the data points having a high importance score.

4. The system of claim 1, wherein the oversampling rate is calculated as a rate of number of times that each feature value of a plurality of features included in the data points is duplicated within the dataset.

5. The system of claim 1, wherein the sample weight is calculated by multiplying a plurality of oversampling rates of the data points.

6. The system of claim 1, wherein the data points are replicated as many times as the calculated sample weight and included in a dataset.

7. A method, which is a computerized method, comprising:
calculating, through a processor, an oversampling rate for each of data points of a dataset stored in a memory;
calculating, through the processor, a sample weight for each of the data points based on the oversampling rate stored in the memory; and
oversampling, through the processor, the data points in correspondence to the calculated sample weight stored in the memory.

8. The method of claim 7, wherein the dataset includes a plurality of data points each composed of a feature vector and a target value of the feature vector.

9. The method of claim 7, further comprising calculating an importance score for the data points, wherein, in the calculating the importance score, a change amount of target values of the data points is calculated to calculate an importance score, and oversampling tubular data is generated by selecting some of the data points having a high importance score.

10. The method of claim 7, wherein the oversampling rate is calculated as a rate of number of times that each feature value of a plurality of features included in the data points is duplicated within the dataset divided by a total number of the data points.

11. The method of claim 7, wherein, in the calculating the sample weight, the sample weight is calculated by multiplying a plurality of oversampling rates of the data points and rounding multiplication results.

12. The method of claim 7, wherein, in the oversampling the data points, the data points are replicated as many times as the calculated sample weight and included in a dataset.

13. An application-specific integrated circuit comprising:
a memory storing information and instructions; and
a functional block including at least one processor requesting access to the memory,
wherein the memory stores instructions or information including:
an operation of calculating an oversampling rate for each of data points of a dataset;
an operation of calculating a sample weight based on the oversampling rate for the data points; and
an operation of oversampling the data points in correspondence to the calculated sample weight.

14. A method, which is a computerized method, comprising:
calculating, through a processor, an oversampling rate of each of data points of a dataset including positive electrode material property information of a tubular form stored in a memory;
calculating, through the processor, a sample weight based on the oversampling rate stored in the memory for each of the data points; and
oversampling, through the processor, the data points in correspondence to the calculated sample weight stored in the memory,
wherein at least some of the positive electrode material property information of the dataset are oversampled and stored in the memory.

15. The method of claim 14, wherein the dataset includes a plurality of data points each composed of a positive electrode material property vector and a target value of the positive electrode material property vector, and the dataset includes positive electrode material property information including a positive electrode active material and doping elements.

16. The method of claim 15, further comprising calculating an importance score for the data points, wherein, in the calculating the importance score, a change amount of target values of the data points is calculated to calculate an importance score, and oversampling tubular data is generated by selecting some of the data points having a high importance score.

17. The method of claim 15, wherein the oversampling rate is calculated as a rate of number of times that each feature value of the doping elements included in the data points is duplicated within the dataset divided by a total number of the data points.

18. The method of claim 14, wherein, in the calculating the sample weight, the sample weight is calculated by multiplying a plurality of oversampling rates of the data points and rounding multiplication results.

19. The method of claim 15, wherein, in the oversampling the data points, the data points are replicated as many times as the calculated sample weight and included in a dataset so that some of the doping elements are oversampled.

20. The method of claim 14, wherein:
the positive electrode material property information includes aluminum, zirconium, magnesium, titanium, boron, fluorine, tungsten, molybdenum, gallium, nitrogen group, and calcium as doping elements for doping the positive electrode material; and
property information of some of the doping elements is oversampled by calculating an oversampling rate and a sample weight for each of the doping elements.

21. The method of claim 20, further comprising:
inputting data-augmented positive electrode material property information into an artificial intelligence model executed by a processor for training; and
predicting a doping condition of the positive electrode material using the trained artificial intelligence model executed by the processor,
wherein, in the predicting, the predicted positive electrode material doping condition is derived as at least one of tungsten/zirconium (W/Zr), tungsten/aluminum (W/Al), or tungsten/titanium (W/Ti).

22. A computing system comprising:
a user computing device; and
a server computing system performing a task corresponding to instructions or data received from the user computing device,
wherein:
the server computing system includes:
a database storing a dataset for training an artificial intelligence model;
a memory storing instructions and data for training the artificial intelligence model and performing the task; and
at least one processor performing the task according to the instructions or data stored in the memory; and
the at least one processor performs operations of:
receiving an oversampling instruction for the dataset from the user computing device;
calculating an oversampling rate for each of data points of the dataset;
calculating a sample weight based on the oversampling rate for the data points, oversampling the data points in correspondence to the calculated sample weight; and
providing an oversampling result to the user computing device.

23. The computing system of claim 22, wherein the at least one processor further performs operations of:
inputting the oversampled dataset to the artificial intelligence model executed by the processor for training;
executing a prediction task based on instructions or data received from the user computing device; and
providing a prediction task result to the user computing device for output.

24. The computing system of claim 22, wherein the dataset includes a plurality of data points each composed of a feature vector and a target value of the feature vector.

25. The computing system of claim 22, wherein:
the at least one processor further performs an operation of calculating an importance score for the data points; and
the operation of calculating the importance score includes:
an operation of calculating a change amount of target values of the data points to calculate the importance score; and
an operation of generating oversampling tubular data by selecting some of the data points having a high importance score.

26. The computing system of claim 22, wherein the oversampling rate is calculated as a rate of number of times that each feature value of a plurality of features included in the data points is duplicated within the dataset divided by a total number of the data points.

27. The computing system of claim 22, wherein the sample weight is calculated by multiplying a plurality of oversampling rates of the data points and rounding multiplication results.

28. The computing system of claim 22, wherein the data points are replicated as many times as the calculated sample weight and included in a dataset.
